(19) United States
(12) Patent Application Publication
(10) Pub. No.: US 2025/0171320 A1
(43) Pub. Date: May 29, 2025

(54) HIGH-PURITY KAOLIN AND PREPARATION METHOD THEREOF

(71) Applicants: CHINA UNIVERSITY OF GEOSCIENCES (WUHAN), Wuhan (CN); Central South University, Changsha (CN)

(72) Inventors: Huaming YANG, Wuhan (CN); Qianwen WU, Wuhan (CN); Han YI, Wuhan (CN); Huichao JI, Wuhan (CN); Linyun LU, Wuhan (CN)

(73) Assignees: CHINA UNIVERSITY OF GEOSCIENCES (WUHAN), Wuhan (CN); Central South University, Changsha (CN)

(21) Appl. No.: 19/027,369

(22) Filed: Jan. 17, 2025

(30) Foreign Application Priority Data
Jan. 19, 2024 (CN) 202410078803.2

(51) Int. Cl. C01B 33/40

(52) U.S. Cl. CPC C01B 33/40; C01P 2002/72; C01P 2004/03; C01P 2004/51; C01P 2004/62; C01P 2006/80; C01P 2006/90

(57) ABSTRACT

A preparation method of kaolin includes the following steps: S1, dispersing specified masses of a crude kaolin ore and a dispersing agent evenly in deionized water, mashing into a slurry, and allowing the slurry to stand for a specified time; and collecting a slurry supernatant, and subjecting the slurry supernatant to centrifugal classification and drying to produce a first dried product for later use; S2, subjecting the first dried product to a reaction with an acid solution, and conducting centrifugal washing and drying to produce a second dried product; and S3, mixing the second dried product with a flocculating agent having a specified concentration, and conducting low-speed stirring at a specified temperature to allow a reaction for a specified time; removing an upper supernatant liquid; and subjecting a lower flocculent precipitate to centrifugal classification and drying to produce high-purity kaolin. A high-purity kaolin with a purity of 98.9% is prepared.

### CROSS-REFERENCE TO RELATED APPLICATIONS

This application claims priority to Chinese Patent Application No. 202410078803.2 with a filing date of Jan. 19, 2024. The content of the aforementioned application, including any intervening amendments thereto, is incorporated herein by reference.

### TECHNICAL FIELD

The present disclosure relates to the technical field of processing of non-metallic mineral materials, and in particular to high-purity kaolin and a preparation method thereof.

### BACKGROUND

As a basic material for ceramics, electronic materials, new antimicrobial materials, anticancer carriers, etc., high-purity kaolin plays a key role in different fields. In the ceramic industry, the refined purification of kaolin can improve the whiteness, transparency, and mechanical properties of kaolin, such that the kaolin is suitable for the preparation of high-end ceramics. In the field of electronic materials, the purity of kaolin is directly related to the insulating properties of dielectric materials. In the field of biomedicine, because it is stipulated in the European INventory of Existing commercial Chemical Substances (EINECS) NO. 215-628-1 that the purity of kaolin needs to reach 95% or more, high-purity kaolin is essential for the preparation of materials with excellent biocompatibility and no harm to the human body. The improvement of the purity of kaolin is conducive to improving the properties of materials and expanding the application fields, and also can increase the market value added of mineral products and promote the sustainable utilization of mineral resources. The refined beneficiation can effectively extract the useful components in kaolin, reduce the waste of resources, alleviate the problem that kaolin resources undergo scattered distribution and include many colored impurities, and improve the comprehensive utilization efficiency of mineral resources, which is in line with the strategic requirements of sustainable development.

The main components in crude kaolin ore are kaolinite minerals. The crude kaolin ore also includes a large number of impurities such as quartz, feldspar, mica, and various iron minerals and iron oxides, and even includes organic matters. Kaolin purification methods include gravity concentration, magnetic separation, flotation, leaching, chemical bleaching, roasting, etc. These methods have respective characteristics, and can be used for removing different types of impurities to improve the whiteness and quality of kaolin. The gravity concentration is mainly used to remove organic matters, feldspar, quartz, etc., and achieves the purification based on density and particle size differences. The gravity concentration needs to be used in combination with calcination, magnetic separation, and leaching to produce a final product. The magnetic separation can remove weakly-magnetic staining impurities. The high-gradient strong magnetic separator can effectively achieve the magnetic separation and purification of kaolin. The flotation can be used to treat crude kaolin ore with many impurities, and achieves the purification through the adsorption and separation of bubbles. The leaching allows the removal of some impurities through the dissolution with a leaching agent, and is simple and energy-saving. The chemical bleaching achieves the removal of staining impurities through chemical reactions, including oxidation, reduction, oxidation-reduction combination, etc. However, the above-mentioned different purification processes exhibit prominent removal effects merely for specific types of impurities. Therefore, how to well remove impurities in kaolin and use purified kaolin in the field of biomedicine is an urgent problem to be solved.

### SUMMARY OF PRESENT INVENTION

An objective of the present disclosure is to provide high-purity kaolin with high purity, low cost, and high biosafety and a preparation method thereof in view of the above-mentioned shortcomings in the prior art. In the preparation method, kaolinite in kaolin is effectively separated from hematite, montmorillonite, and quartz through a physical-chemical combined process to produce high-purity kaolin.

To achieve the above objective, the present disclosure adopts the following technical solutions:

A first objective of the present disclosure is to provide a preparation method of high-purity kaolin, including the following steps:
S1, crushing and screening a natural crude kaolin ore to produce a kaolin powder; mixing the kaolin powder with deionized water and a dispersing agent according to a specified solid-to-liquid ratio, and stirring at a specified speed for a specified time to produce a slurry; allowing the slurry to stand for a specified time, and collecting a slurry supernatant through siphonage; and subjecting the slurry supernatant to centrifugal classification and drying to produce a physically-purified ore;
S2, subjecting the physically-purified ore obtained in the S1 to a reaction with 16% to 32% sulfuric acid at a specified temperature for a specified time to produce a mixture, washing the mixture with deionized water multiple times until a pH is 7.0, and drying to produce a purified kaolin ore with hematite removed; and
S3, mixing the purified kaolin ore obtained in the S2 with a nonionic polyacrylamide, and conducting low-speed stirring at a specified temperature to allow a reaction for a specified time; removing an upper waste supernatant liquid through siphonage; and subjecting a lower flocculent precipitate to centrifugal classification and dewatering and drying to produce high-purity kaolin.

Further, in the S1, the solid-to-liquid ratio of the kaolin powder to the deionized water is (5-160) g:100 mL, the stirring is conducted at 1,000 rpm to 1,500 rpm for 60 min to 120 min, and the slurry is allowed to stand for 5 min to 60 min.

Further, in the S1, the centrifugal classification is conducted by a centrifuge with a centrifugation speed of 2,000 rpm to 7,000 rpm and a centrifugation time of 5 min to 10 min to produce a supernatant and a precipitate; and the supernatant is retained as a product for subsequent purification, and the precipitate is discarded.

Further, in the S2, a solid-to-liquid ratio of the physically-purified ore to the 16% to 32% sulfuric acid is 1 g:(1-20) mL, and the reaction is conducted at 60° C. to 65° C. for 60 min to 180 min.

Further, in the S2, the drying is conducted at 30° C. to 70° C. for 120 min to 600 min.

Further, in the S3, a solid-to-liquid ratio of the purified kaolin ore to the nonionic polyacrylamide is (1-5):100, the low-speed stirring is conducted at 50 rpm to 500 rpm for 60 min to 240 min, and the dewatering and drying is conducted at 30° C. to 70° C. for 120 min to 600 min.

A second objective of the present disclosure is to provide high-purity kaolin prepared by the preparation method.

Further, in the high-purity kaolin, a content of kaolinite is not less than 98.5% and a content of quartz is not more than 0.4%.

Further, a particle size distribution of the high-purity kaolin is as follows: D₅₀: 361 nm to 365 nm, and D₉₀: 635 nm to 670 nm.

Further, a zeta potential of the high-purity kaolin is −36 mV to −37 mV.

Compared with the prior art, the present disclosure has the following beneficial effects:
(1) The present disclosure adopts low-price natural kaolin with abundant reserves as a raw material to prepare high-purity kaolin with a purity of 98.9% through a physical-chemical combined process. In the present disclosure, the impurity quartz is first removed through a physical process, then the hematite is removed with an acid solution, and finally the montmorillonite is removed through selective flocculation. The present disclosure effectively separates kaolinite in kaolin from hematite, montmorillonite, and quartz to produce high-purity kaolin.
(2) In the high-purity kaolin prepared by the method provided in the present disclosure, a content of kaolinite is not less than 98.5% and a content of quartz is not more than 0.4%. A particle size distribution of the high-purity kaolin is as follows: D₅₀: 361 nm to 365 nm, and D₉₀: 635 nm to 670 nm. The high-purity kaolin has a pore size of 1 nm to 10 nm, which increases by 6 times compared with the crude kaolin ore. A zeta potential of the high-purity kaolin is −36 mV to −37 mV. An absolute value of the zeta potential of the high-purity kaolin prepared in the present disclosure is greater than 30 mV. As a result, even if there is an electrostatic repulsion, a suspension system of the high-purity kaolin can maintain stable. Therefore, the high-purity kaolin can be well used as a biological material in the field of biomedicine.
(3) A product of the method of the present disclosure has superior properties such as high purity, low cost, high biosafety, and wide application range, and exhibits a promising practical application prospect. Thus, the method provides a technical support for the industrial production of natural kaolin, and also has specified guiding significance for the processing, purification, and industrial production of the same type of ores.

### BRIEF DESCRIPTION OF THE DRAWINGS

FIG. 1a shows an X-ray diffraction pattern of a crude kaolin ore;

FIG. 1b shows an X-ray diffraction pattern of a high-purity kaolin concentrate;

FIG. 2 shows a scanning electron microscopy image of the high-purity kaolin concentrate;

FIG. 3a shows N₂ adsorption/desorption curves of the crude kaolin ore and the high-purity kaolin concentrate;

FIG. 3b shows BJH pore size distribution curves of the crude kaolin ore and the high-purity kaolin concentrate;

FIG. 4 is a zeta potential diagram of the crude kaolin ore and the high-purity kaolin concentrate;

FIG. 5; is a particle size graph of the crude kaolin ore and the high-purity kaolin concentrate;

FIG. 6 is a cytotoxicity diagram of the high-purity kaolin (pharmaceutical grade kaolinite) of the present disclosure at different concentrations.

### DETAILED DESCRIPTION OF THE EMBODIMENTS

In order to make the objective, technical solutions, and advantages of the present disclosure clear, the embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary. These embodiments are only used to explain the present disclosure, and should not be construed as a limitation to the present disclosure.

The crude kaolin ore adopted in the present disclosure comes from Nankang District, Ganzhou City, Jiangxi Province.

The term “high-purity,” as used herein, refers to kaolin that has a content of kaolinite not less than 95%.

### Example 1

In this example, physically-purified kaolin was prepared through physical purification with different dispersant contents (0% to 0.8%).

A dispersing agent was added at 0%, 0.2%, 0.4%, 0.6%, and 0.8% to 1,000 mL of a kaolin slurry, and high-speed stirring was conducted by a stirrer for 120 min. After the high-speed stirring was completed, free sedimentation was allowed for 60 min. After the free sedimentation was completed, a resulting supernatant was collected through siphonage, then transferred to a 50 mL centrifuge tube, and washed multiple times through centrifugation at 2,000 rpm until a clear supernatant was produced. The clear supernatant was kept at 65° C. for 300 min to allow drying to produce physically-purified kaolin.

### Example 2

In this example, physically-purified kaolin was prepared at different centrifugation speeds (500 rpm to 7,000 rpm).

0.4% of a dispersing agent was added to 1,000 mL of a kaolin slurry, and centrifugal classification was conducted for 5 min by a centrifuge with centrifugation speeds of 500 rpm, 1,000 rpm, 2,000 rpm, 3,000 rpm, 5,000 rpm, and 7,000 rpm. After the centrifugal classification was completed, a resulting supernatant was transferred to a 50 mL centrifuge tube and centrifuged multiple times at 7,000 rpm until a clear supernatant was produced. The clear supernatant was kept at 65° C. for 300 min to allow drying to produce physically-purified kaolin.

### Example 3

In this example, hematite was removed with different solid-to-liquid ratios of physically-purified kaolin to a sulfuric acid solution (1:(1-20)) to produce chemically-purified kaolin.

0.4% of a dispersing agent was added to 1,000 mL of a kaolin slurry, mechanical stirring was conducted for 120 min, and standing was allowed for 60 min. A resulting slurry supernatant was collected through siphonage, and subjected to centrifugal classification for 5 min by a centrifuge with a centrifugation speed of 2,000 rpm to produce a product. The product was dried to produce physically-purified kaolin. According to solid-to-liquid ratios of 1:1, 1:5, 1:10, 1:15, and 1:20, 16% to 32% sulfuric acid was added at 60° C. to the physically-purified kaolin, and low-speed stirring was conducted with a low-speed stirrer. A resulting acid-leaching system was subjected to centrifugal classification for 5 min by a centrifugal classifier at 7,000 rpm. A leached product was discarded with a centrifugal supernatant. A purified product was retained with a centrifugal precipitate, and finally kept at 65° C. for 300 min to allow drying to produce chemically-purified kaolin.

### Example 4

In this example, montmorillonite was removed with different flocculating agents to produce high-purity kaolin.

1 g of chemically-purified kaolin was weighed and subjected to a reaction for 180 min with each of 1 L of deionized water, 5 mg/L of anionic polyacrylamide, 5 mg/L of cationic polyacrylamide, and 5 mg/L of nonionic polyacrylamide in a low-speed stirrer to produce mixtures. The mixtures each were washed multiple times until a pH was 7.0, and finally dried to produce high-purity kaolin concentrates with purities of 97.8%, 92.4%, and 98%, respectively. The results indicated that nonionic polyacrylamide is an important optimization condition.

### Example 5

In this example, montmorillonite was removed at different flocculation pH values (3 to 10) to prepare high-purity kaolin.

1 g of chemically-purified kaolin and 5 mg/L of nonionic polyacrylamide were weighed and subjected to a reaction for 240 min at 300 rpm in solutions with pH values of 3, 4, 6, 7, 9, and 10 to produce mixtures. The mixtures each were washed multiple times until a pH was 7.0, and finally dried to produce high-purity kaolin concentrates with purities of 93%, 92.6%, 94.3%, 95.1%, 98.6%, and 96.7%, respectively. The results indicated that the pH affected the ability of a flocculating agent to flocculate gangue minerals, and the optimal pH was 9.

### Example 6

In this example, montmorillonite was removed at different mashing speeds (50 rpm to 500 rpm) to prepare high-purity kaolin.

1 g of chemically-purified kaolin and 5 mg/L of nonionic polyacrylamide were weighed and subjected to a reaction at mashing speeds of 50 rpm, 100 rpm, 200 rpm, 300 rpm, 400 rpm, and 500 rpm in a solution with a pH of 9 to produce mixtures. The mixtures each were washed multiple times until a pH was 7.0, and finally dried to produce high-purity kaolin concentrates with purities of 90.2%, 92.5%, 95.3%, 98.9%, 98.4%, and 95.7%, respectively. The results indicated that the mashing speed also affected the ability of a flocculating agent to flocculate gangue minerals, and the optimal mashing speed was 300 rpm.

### Example 7

In this example, the correlation between steps was investigated by adjusting an order of S2 and S3.

A natural crude kaolin ore was crushed and screened to produce a kaolin powder. The kaolin powder was mixed with deionized water and a dispersing agent at a mass 0.4% of a mass of the kaolin powder according to a specified solid-to-liquid ratio, and stirring was conducted at a specified speed for a specified time to produce a slurry. The slurry was allowed to stand for 90 min. A resulting slurry supernatant was collected through siphonage, subjected to centrifugal classification, and dried to produce physically-purified kaolin. The physically-purified kaolin and nonionic polyacrylamide were subjected to a reaction for a specified time at a specified temperature under low-speed stirring. An upper waste supernatant liquid was removed through siphonage. A lower flocculent precipitate was subjected to centrifugal classification and dewatering and drying to produce chemically-purified kaolin. Finally, the chemically-purified kaolin was subjected to a reaction for a specified time with sulfuric acid according to a solid-to-liquid ratio of 1:5 to produce a mixture. The mixture was washed multiple times with deionized water until a pH was 7.0, and then dried to produce purified kaolin. The above process was repeated three times. Purified kaolin ores of the above processhad purities of 73.3%, 70.3%, and 68.2%, respectively, indicating that the purity was greatly reduced. Zeta potentials corresponding to the different purities were −16.17 mV, −2.41 mV, and 0.95 mV, respectively, which did not meet the potential requirement of high-purity kaolin. The results indicated that the adjustment of the experimental steps made flocculation products agglomerate and greatly reduced the acid-leaching effect.

In order to well elaborate the properties of the high-purity kaolin prepared in the present disclosure, the applicants carried out the following research:

### Performance Characterization:

The high-purity kaolin concentrates prepared in Examples 4 to 6 had similar performance characteristics. The high-purity kaolin concentrate prepared in Example 6 was taken as a representative for explanation below.

Table 1 shows the comparison of specific surface areas, pore volumes, and pore sizes of the crude kaolin ore and the high-purity kaolin concentrate. The high-purity kaolin concentrate produced after treating the crude kaolin ore by the physical-chemical combined process has a specific surface area increasing from 13.92 m²/g to 73.44 m²/g, a pore volume increasing from 0.05 cm³/g to 0.31 cm³/g, and a pore size increasing slightly to 16.65 nm.

TABLE 1
Specific surface areas, pore volumes,
and pore sizes of the crude kaolin
ore and the high-purity kaolin concentrate

| | Specific surface | | |
|---|---|---|---|
| | area | Pore volume | Pore size |
| Crude kaolin ore | 13.92 m²/g | 0.05 cm³/g | 14.94 nm |
| High-purity kaolin | 73.44 m²/g | 0.31 cm³/g | 16.65 nm |
| concentrate | | | |

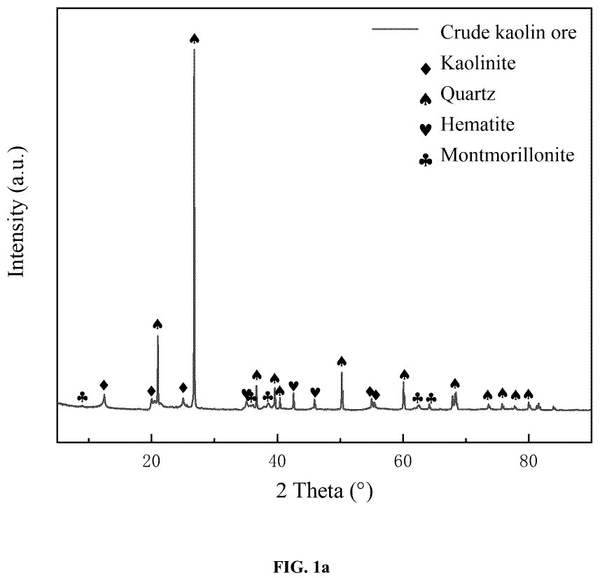

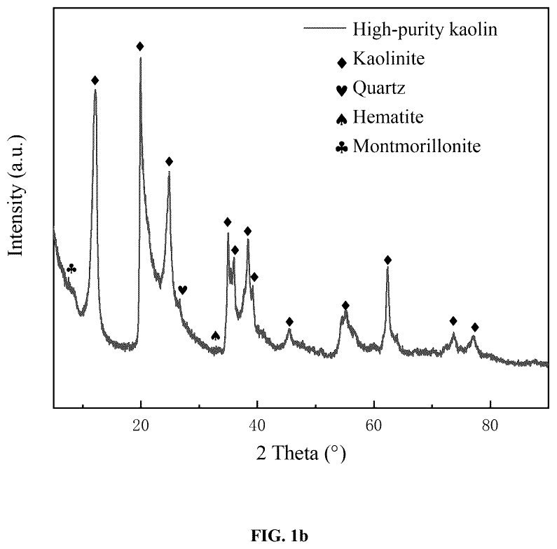

FIG. 1a shows an X-ray diffraction pattern of a crude kaolin ore. It can be seen from this figure that main phases in the crude kaolin ore are montmorillonite, quartz, and hematite. A characteristic peak of quartz has a sharp shape and a high intensity, indicating that the quartz in the crude kaolin ore has excellent crystallinity and a high crystal order. A content of quartz is high, and thus quartz is a main gangue mineral in the crude kaolin ore. Characteristic peaks of hematite and montmorillonite have low relative intensities, indicating that contents of hematite and montmorillonite are lower than the content of quartz and hematite and montmorillonite are minor gangue minerals in the crude kaolin ore. According to the multi-phase Rietveld quantitative analysis, in the crude kaolin ore, a content of kaolinite is 36.9%, and a content of quartz is 49.2%.

FIG. 1b shows an X-ray diffraction pattern of the high-purity kaolin concentrate. It can be seen from this figure that, after the purification by the physical-chemical combined process, the X-ray diffraction pattern undergoes peak shape changes. The characteristic peak of the gangue mineral montmorillonite basically disappears, indicating that the gangue mineral montmorillonite has been effectively removed by the physical process. In addition, compared with the crude kaolin ore, peak intensities of the characteristic peaks of the impurities quartz and hematite both are greatly reduced after the chemical purification, indicating that the process can effectively remove the quartz and hematite. According to the multi-phase Rietveld quantitative analysis, in the high-purity kaolin concentrate, a content of kaolinite is 98.9%, and a content of quartz is 0.4%.

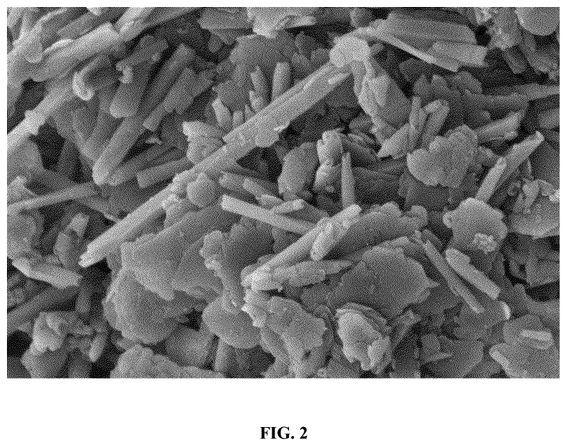

FIG. 2 shows a scanning electron microscopy image of the high-purity kaolin concentrate. It can be seen from this figure that the high-purity kaolin concentrate is mainly accordion-like kaolinite, the gangue minerals on the surface have been mostly removed, free fine-grained quartz is merely observed in some regions, and there is no regularly-hexagonal flake-like hematite and flocculent montmorillonite in the field of vision. Moreover, it has been found that tabular kaolinite has mostly been stripped and curled into nano-rolls.

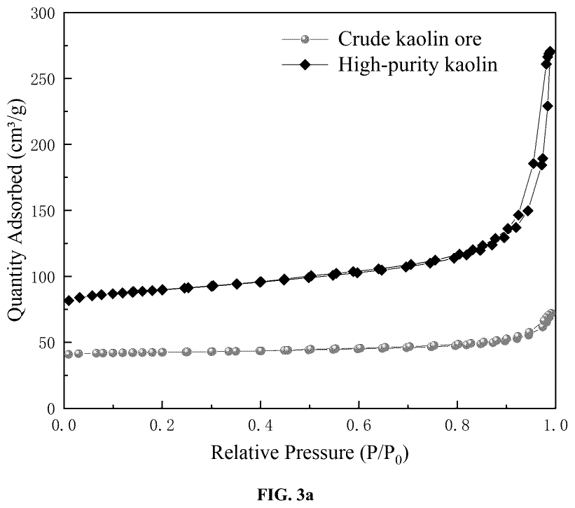

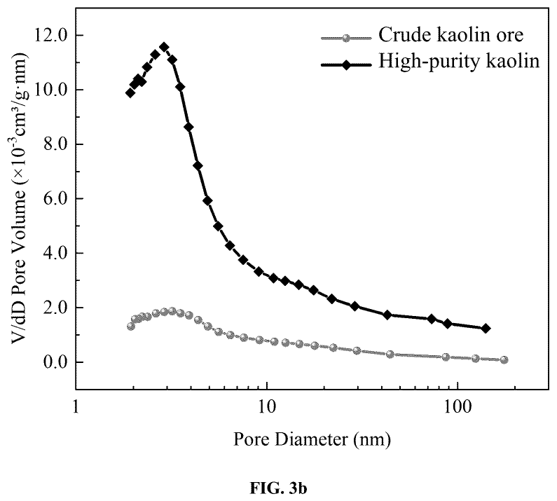

FIG. 3a shows N₂ adsorption/desorption curves of the crude kaolin ore and the high-purity kaolin concentrate. As shown in this figure: An adsorption/desorption isotherm of the crude kaolin ore can only be vaguely identified as type II. An adsorption/desorption isotherm of the high-purity kaolin concentrate belongs to type IV, and a hysteresis loop of the adsorption/desorption isotherm belongs to type H3. This hysteresis loop type also proves that the material is a clay sheet material, and is a typical clay adsorption/desorption characteristic. In addition, the nitrogen adsorption-desorption isotherm increases, indicating that the corresponding mesopores are abundant.

FIG. 3b shows BJH pore size distribution curves of the crude kaolin ore and the high-purity kaolin concentrate. It can be seen from this figure that, after the purification and modification, although a pore size does not change significantly, a number of pores with a pore size of 1 nm to 10 nm in the high-purity kaolin concentrate increases significantly, which is about 6 times higher than that in the crude kaolin ore. This may be because kaolinite in the kaolin is effectively stripped to expose increased slit pores, which greatly improves the drug-loading space.

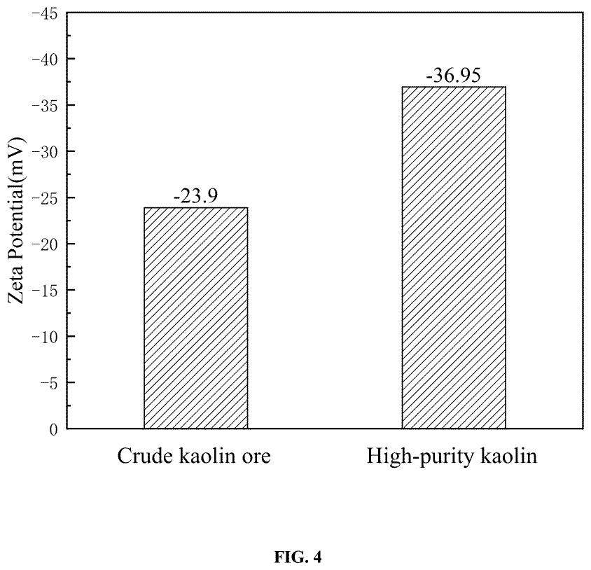

FIG. 4 is a zeta potential diagram of the crude kaolin ore and the high-purity kaolin concentrate. It can be seen from this figure that zeta potential values of the crude kaolin ore and the high-purity kaolin concentrate are −23.9 mV and −36.95 mV, respectively. An absolute potential value of the high-purity kaolin concentrate is greater than an absolute potential value of the crude kaolin ore, indicating that the more stable the suspension of the high-purity kaolin concentrate, the more the positively-charged anti-cancer drug that can be loaded, which increases a loading rate of the cationic anti-cancer drug.

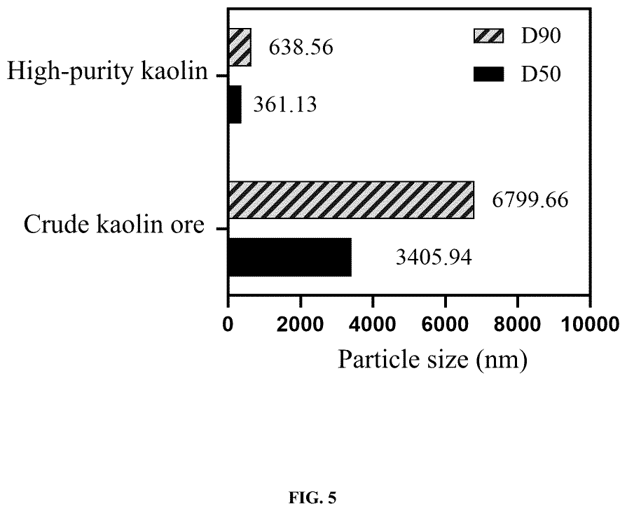

FIG. 5 shows particle size distributions of the crude kaolin ore and the high-purity kaolin concentrate. It can be seen from this figure that the purification method can lead to nano-scale high-purity kaolin with a D₅₀ value reduced from 3,405.94 nm to 361.13 nm and a D₉₀ value of only 638.56 nm, indicating that high-purity kaolin nanosheets have been successfully prepared, which are suitable for applications in the field of biomedicine.

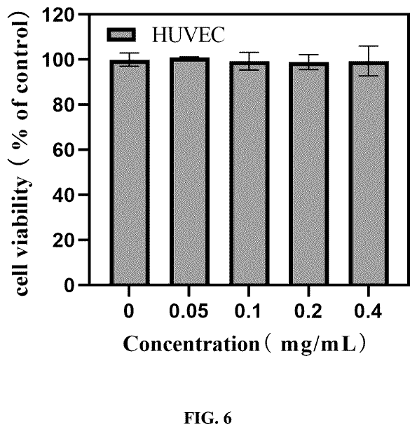

FIG. 6 is a cytotoxicity diagram of different concentrations of the high-purity kaolin concentrate of the present disclosure for human umbilical vein endothelial cells (HUVECs) with the highest sensitivity to kaolinite. When a concentration of the high-purity kaolin concentrate increases from 0.05 mg/mL to 0.4 mg/mL, a survival rate of cells is close to 100%, indicating that the high-purity kaolin has low cytotoxicity. It can be known that the high-purity kaolin prepared by the present disclosure has high biosafety and can be used as pharmaceutical grade kaolinite.

In some embodiments, the high-purity kaolin concentrate has a small particle size of 200 nm to 640 nm, a high porosity of 1 nm to 10 nm, an enhanced ion-exchange capacity, and an absolute zeta potential value of greater than 30 mV, and exhibits excellent biocompatibility. The high-purity kaolin can be widely used in the field of biomedicine, including, but not limited to the following examples, preparation of hemostatic materials, drug carriers, and antimicrobial materials, and tissue engineering.

What is not mentioned above can be acquired in the prior art.

Although some specific embodiments of the present disclosure have been described in detail by way of examples, those skilled in the art will appreciate that the above examples are provided for illustration only and not for limiting the scope of the present disclosure. A person skilled in the art can make various modifications or supplements to the specific embodiments described or replace them in a similar manner, but it may not depart from the direction of the present disclosure or the scope defined by the appended claims. Those skilled in the art should understand that any modification, equivalent replacement, and improvement made to the above embodiments according to the technical essence of the present disclosure shall be included in the protection scope of the present disclosure.

What is claimed is:

1. A preparation method of kaolin, comprising the following steps:
S1, crushing and screening a natural crude kaolin ore to produce kaolin powder; mixing the kaolin powder with deionized water and a dispersing agent according to a specified solid-to-liquid ratio, and stirring at a specified speed for a specified time to produce a slurry; allowing the slurry to stand for a specified time, and collecting a slurry supernatant through siphonage; and subjecting the slurry supernatant to centrifugal classification and drying to produce a physically-purified ore;
S2, subjecting the physically-purified ore obtained in the S1 to a reaction with 16% to 32% sulfuric acid at a specified temperature for a specified time to produce a mixture, washing the mixture with deionized water multiple times until a pH is 7.0, and drying to produce chemically-purified kaolin with hematite removed; and
S3, mixing the chemically-purified kaolin obtained in the S2 with a nonionic polyacrylamide, and conducting stirring at a specified speed and a specified temperature to allow a reaction for a specified time; removing an upper waste supernatant liquid through siphonage; and subjecting a lower flocculent precipitate to centrifugal classification and dewatering and drying to produce a kaolin concentrate.

2. The preparation method according to claim 1, wherein in the S1, the solid-to-liquid ratio of the kaolin powder to the deionized water is (5-16) g:100 mL, the stirring is conducted at 1,000 rpm to 1,500 rpm for 60 min to 120 min, and the slurry is allowed to stand for 5 min to 60 min.

3. The preparation method according to claim 1, wherein in the S1, the centrifugal classification is conducted by a centrifuge with a centrifugation speed of 2,000 rpm to 7,000 rpm and a centrifugation time of 5 min to 10 min to produce a supernatant and a precipitate; and the supernatant is retained as a product for subsequent purification, and the precipitate is discarded.

4. The preparation method according to claim 1, wherein in the S2, a solid-to-liquid ratio of the physically-purified ore to the 16% to 32% sulfuric acid is 1 g:(1-20) mL, and the reaction is conducted at 60° C. to 65° C. for 60 min to 180 min.

5. The preparation method according to claim 1, wherein in the S2, the drying is conducted at 30° C. to 70° C. for 120 min to 600 min.

6. The preparation method according to claim 1, wherein in the S3, a solid-to-liquid ratio of the chemically-purified kaolin to the nonionic polyacrylamide is (1-5):100, the stirring is conducted at 50 rpm to 500 rpm for 60 min to 240 min, and the dewatering and drying is conducted at 30° C. to 70° C. for 120 min to 600 min.

7. Kaolin prepared by the preparation method according to claim 1.

8. The kaolin according to claim 7, wherein in the kaolin, a content of kaolinite is not less than 98.5% and a content of quartz is not more than 0.4%.

9. The kaolin according to claim 7, wherein a particle size distribution of the kaolin is as follows: D₅₀: 361 nm to 365 nm, and D₉₀: 635 nm to 670 nm.

10. The kaolin according to claim 7, wherein a zeta potential of the kaolin is −36 mV to −37 mV.
